(19) United States
(12) Patent Application Publication
(10) Pub. No.: US 2008/0109285 A1
(43) Pub. Date: May 8, 2008

(54) TECHNIQUES FOR DETERMINING RELEVANT ADVERTISEMENTS IN RESPONSE TO QUERIES

(75) Inventors: Phyllis Reuther, Woodside, CA (US); David Kurtz, Redwood City, CA (US); Michael Connor, Oakland, CA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: Mobile Content Networks, Inc., Mountain View, CA (US)

(21) Appl. No.: 11/925,354

(22) Filed: Oct. 26, 2007

Related U.S. Application Data
(60) Provisional application No. 60/863,088, filed on Oct. 26, 2006.

(51) Int. Cl. G06Q 10/00; G06F 17/30; G06Q 30/00

(52) U.S. Cl. 705/7; 707/5; 705/14; 707/E17.014

(57) ABSTRACT

Techniques for determining relevant advertisements in response to queries is disclosed. According to an exemplary embodiment of the present disclosure, the techniques may be realized as a computer implemented method for determining relevant advertisements in response to a query. The method may comprise: receiving a query from a user device; categorizing the query to identify one or more relevant advertisement sources; formatting the query according to one or more advertisement source specifics for the one or more advertisement sources; transmitting the formatted query to the one or more advertisement sources; merging results in response to the formatted query to the one or more advertisement sources; merging results based at least in part on one or more factors; and formatting the results for delivering to the user device.

### CROSS REFERENCE TO RELATED APPLICATIONS

This application claims priority to U.S. Provisional Application No. 60/863,088, filed Oct. 26, 2006, titled “Method and System for Determining Relevant Advertisements in Response to Queries,” which is incorporated herein by reference in its entirety.

### FIELD OF THE DISCLOSURE

The present disclosure relates generally to computerized techniques for information retrieval, and more particularly to techniques for determining relevant advertisements in response to queries.

### BACKGROUND INFORMATION

Inexpensive computer and networking technologies have made digital content accessible to millions of consumers via wired and wireless networks. The millions of consumers are potential targets of advertisers who are trying to deliver advertisement to the millions of consumers. Advertisers may work with advertisement agencies, which then provide advertisement to companies that perform online advertisement delivery. Online advertisement delivery is therefore an enormous money making opportunity of delivering relevant advertisement to customers via wired and wireless networks.

Currently, online advertisement delivery system may be based on text and data search technologies, which has provided significant practical and commercial value and also resulted in a proliferation and commoditization of advertisement search and retrieval.

Text and data search technologies may be implemented in advertisement networks, which may refer to computer programs designed to index, store, and retrieve information based on instructions from the user. Most contemporary advertisement networks are designed pre-index a collection of resources (e.g. document, image, web site), then in response to a query (e.g., a request with one or more keywords), examine collections in one or a group of computers for content that satisfies the query and return an ordered list of possible matches to the user as a results set. This results set normally contains, at a minimum, the locations of relevant content. Many times, this result list may also include a title, a synopsis, pricing, and/or other metadata, where meaningful. A result item indicating relevance ranking, how closely the content matches the query, may be explicitly returned or may be given implicitly in the order of items in the results set, with the most relevant item at the top of the list. Rankings may be based on a numerical similarity scoring value or one of many possible metrics previously computed against the content and stored in a full-text or database index. An online advertisement delivery system may be implemented by advertisement networks, which works with either internal advertisement collections or external advertisement agencies (e.g., advertisement vendors). To be successful in consumer acceptance and marketing, an online advertisement delivering system must maintain and improve the relevance of advertising messages to the consumer.

The changing nature of digital information access plays a part in increasing the value of precision. In addition to traditional content access via stationary computers, there has been an explosive proliferation of internet access using mobile computing devices such as laptops, personal digital assistants (PDAs), and mobile telephones. This proliferation is markedly changing the nature of content access while content providers (including advertisement agencies) reformat and reorganize their content for mobile access. While a desktop computer user can comfortably access online information, using multiple tries and browsing, mobile computing users are generally limited by small screen and input ergonomics, location-specificity, and their own mobility. Due to these constraints, mobile computing users are less likely to want to receive all possibly relevant advertisement, and more likely to want specific advertisement immediately, with the highest possible precision in the first five to ten entries of the results set. For the same reasons, mobile users also require the shortest path to their desired content. Therefore, advertisement results items links should take the user directly to the content rather than to an advertisement provider site.

As there is a plethora of competing advertisement agencies available, it is a difficult decision to choose one that will satisfy all the needs of the online advertisement delivering system. Advertisement agencies generally maximize their return on investment by specializing in geographic regions, advertisement types, or publishing medium. Choosing one or more advertisement agencies to provide advertisement content may be a challenging task. For example, an online advertisement delivering system may be run by a multi-national company with multiple publishing vehicles. Both technical and business relationships may influence partner selection and advertisement inclusion for the online advertisement delivering system. Thus, the online advertisement delivering system may be forced to have a flexible solution. For example, one solution may be to choose the advertisement agencies that are best of breed for a particular ad type, reaching down to regional and local agencies when they are available, supplementing where necessary with large-scale, general agencies. A more flexible solution, which may be used on top of the first solution, is to submit query to multiple advertisement agencies and either return the most useful ad or merge the multiple ad result sets based on the relevance ranking.

Applicable advertisement network query and indexing architectures for implementing the more flexible solution described above may be federated advertisement system. A federated advertisement system may combine results from more than one search, with each search typically being conducted over heterogeneous content sources (e.g., full-text and/or multimedia advertisement provided by different advertisement vendors). However, technically, having the more flexible solution with multiple advertisement agencies would appear to be an integration nightmare for developers because each advertisement agency may have specific requirement to be integrated with an online advertisement delivery system as an advertisement vendor. Moreover, some advertisement agencies may have an exclusivity requirement, which precludes merging their result items with result items from other advertisement agencies. Therefore, to avoid the technical and/or contractual difficulties for integration, some online advertisement systems may not take advantage of the federated advertisement systems and may compromise the relevancy of the advertisement by sticking with large-scale, general agencies.

Another obstacle for implementing a federated advertisement system may be the scope of relevancy ranking. For a federated advertisement system to be maximally precise, it should find the resources that score highest with respect to the metacollection (e.g., the combined advertisement collections of searched vendors), not necessarily those that score highest with respect to the individual source in which they reside. For example, in a federated advertisement system query over the combination of two different advertisement vendors: sports and computer hardware; if the query contains the term “games,” an incorrect implementation may give undue weight to sports games that appear in the sports collection. The practical impacts of this effect are substantial to the extent that a metacollection is used to cull information from diverse sources, each with a different specialty or focus.

Other challenges to federated advertisement system functionality may also be present. Different advertisement vendors may index their advertisement collections using different algorithms or by processing the same algorithms against different sections of text and/or metadata. Thus local advertisement vendor calculated ranking statistics may not be compared directly when combining results sets. Moreover, different advertisement vendors may contain overlapping advertisement collections, which may result in the same advertisement item appearing in results sets from both sources. Traditional de-duplication algorithms remove all duplicates based on a metadata field value or set of field values, which may not be the desired action. Further, various advertisement vendors may contain similar advertisement but include varying depth of advertisement (extensiveness of the collection) or may vary in response characteristics (latency, percent uptime). These variations can negatively impact the user experience by generating insufficient results or by not responding before system or user-perceived timeouts. Additionally, there may be wide variation in relevance of a content collection to the query. There may be times that not all available advertisement vendors contain collections sufficiently relevant to warrant inclusion in the metacollection.

In view of the foregoing, it may be understood that there are significant problems and shortcomings associated with current online advertisement delivery technologies.

### SUMMARY OF THE DISCLOSURE

Techniques for determining relevant advertisements in response to queries is disclosed. According to an exemplary embodiment of the present disclosure, the techniques may be realized as a computer implemented method for determining relevant advertisements in response to a query. The method may comprise: receiving a query from a user device; categorizing the query to identify one or more relevant advertisement sources; formatting the query according to one or more advertisement source specifics for the one or more advertisement sources; transmitting the formatted query to the one or more advertisement sources; merging results in response to the formatted query to the one or more advertisement sources; merging results based at least in part on one or more factors, and formatting the results for delivering to the user device

In accordance with other aspects of this exemplary embodiment of the present disclosure, the user device may comprise one or more of an internet-enabled input device, an internet or voice-enabled mobile device, a voice-enabled input device, a computer, and a kiosk.

In accordance with further aspects of this particular exemplary embodiment, the one or more factors may comprise one or more global factors, local factors, editorial rating, response reliability, response latency, content relevance, content extensiveness or coverage, user preferences, usage statistics, query frequency, category frequency, distributor preferences, recommendation statistics, user-generated ratings, business relationships, user demographic characteristics, location, language, social networks, social groups, personalization characteristics, page size, graphic, text elements, source rating, reliability factor, business rules, business relationships, marketing goals, local ranking scores, source ordering values, source-specific general scores, statistics associated with results item textual or non-textual analysis, statistics associated with data or text mining analyses, statistics associated with data or textual clustering, statistics associated with non-textual pattern analysis, statistics associated with device specifics and/or statistics associated with formatting specifications.

In accordance with additional aspects of this particular exemplary embodiment, the query may be classified into a category in one or more taxonomy or controlled vocabulary.

In accordance with one aspect of this particular exemplary embodiment, the method may further comprise dynamically computing one or more local ranking statistics for each results item related to one or more terms associated with the query and related to metadata in the query context in response to the query, at each advertisement source.

In accordance with another aspect of this particular exemplary embodiment, the method may further comprise: computing at least one global and/or one local statistic related to one or more content items in the results sets, determining one or more relevancy scores for the results items from the one or more advertisement sources in accordance with the at least one global and/or one local statistic, computing a normalization factor, normalizing the one or more relevancy scores in accordance with the normalization factor, and combining the results into a single results set based on an ordering determined by the normalization factor.

In accordance with yet another aspect of this particular exemplary embodiment, the method may further comprise: storing results from each advertisement source in one or more caches, accessing the one or more caches to retrieve existing results, and formatting the retrieved existing results based on one or more query context parameters.

In accordance with still another aspect of this particular exemplary embodiment, categorizing the query occurs dynamically at the time query is received.

In accordance with a further aspect of this particular exemplary embodiment, the method may further comprise: identifying one or more duplicate result items. Moreover, the method may comprise removing the one or more duplicate result items according to one or more of user preference, device preference and distributor preference. Alternatively, the method may comprise retaining the one or more duplicate results according to one or more of user preference, device preference and distributor preference.

In accordance with a yet further aspect of this particular exemplary embodiment, a computer readable media may comprise code to perform the acts of the method.

In another particular exemplary embodiment, the techniques may be realized as a system for determining relevant advertisements in response to a query. The system may comprise: a receiving module for receiving a query from a user device, a categorizing module for categorizing the query to identify one or more advertisement sources, a formatting module for formatting the query according to one or more advertisement source specifics for the one or more advertisement sources, a transmitting module for transmitting the formatted query to the one or more advertisement sources, a merging module for merging results in response to the formatted query from the one or more advertisement sources based at least in part on one or more factors, and a results module for formatting the results for delivering to the user device.

In accordance with other aspects of this exemplary embodiment of the present disclosure, the user device may comprise one or more of an internet-enabled input device, an internet or voice-enabled mobile device, a voice-enabled input device, a computer, and a kiosk.

In accordance with further aspects of this particular exemplary embodiment, the one or more factors may comprise one or more global factors, local factors, editorial rating, response reliability, response latency, content relevance, content extensiveness or coverage, user preferences, usage statistics, query frequency, category frequency, distributor preferences, recommendation statistics, user-generated ratings, business relationships, user demographic characteristics, location, language, social networks, social groups, personalization characteristics, page size, graphic, text elements, source rating, reliability factor, business rules, business relationships, marketing goals, local ranking scores, source ordering values, source-specific general scores, statistics associated with results item textual or non-textual analysis, statistics associated with data or text mining analyses, statistics associated with data or textual clustering, statistics associated with non-textual pattern analysis, statistics associated with device specifics and/or statistics associated with formatting specifications.

In accordance with additional aspects of this particular exemplary embodiment, the query may be classified into a category in one or more taxonomy or controlled vocabulary.

In accordance with one aspect of this particular exemplary embodiment, the system may further comprise a module for dynamically computing one or more local ranking statistics for each results item related to one or more terms associated with the query and related to metadata in the query context in response to the query, at each advertisement source.

In accordance with another aspect of this particular exemplary embodiment, the system may further comprise: a module for computing at least one global and/or one local statistic related to one or more content items in the results sets, wherein one or more relevancy scores are determined for the results items from the one or more advertisement sources in accordance with the at least one global and/or one local statistic; and a module for computing a normalization factor, wherein the one or more relevancy scores are normalized in accordance with the normalization factor; and the results are combined into a single results set based on an ordering determined by the normalization factor.

In accordance with yet another aspect of this particular exemplary embodiment, the system may further comprise one or more caches for storing results from each advertisement source. The one or more caches may be accessed to retrieve existing results; and the retrieved existing results may be formatted based on one or more query context parameters.

In accordance with still another aspect of this particular exemplary embodiment, categorizing the query occurs dynamically at the time query is received.

In accordance with a further aspect of this particular exemplary embodiment, one or more duplicate results may be identified. Moreover, the one or more duplicate results may be removed according to one or more of user, device and distributor preferences. Alternatively, the one or more duplicate results may be retained according to one or more of user, device and distributor preferences.

The present disclosure will now be described in more detail with reference to exemplary embodiments thereof as shown in the accompanying drawings. While the present disclosure is described below with reference to exemplary embodiments, it should be understood that the present disclosure is not limited thereto. Those of ordinary skill in the art having access to the teachings herein will recognize additional implementations, modifications, and embodiments, as well as other fields of use, which are within the scope of the present disclosure as described herein, and with respect to which the present disclosure may be of significant utility.

### BRIEF DESCRIPTION OF THE DRAWINGS

In order to facilitate a fuller understanding of the present disclosure, reference is now made to the appended drawings. These drawings should not be construed as limiting the present disclosure, but are intended to be exemplary only.

FIG. 1 is an exemplary diagram of a system for federated advertisement searching to multiple advertisement sources, according to an embodiment of the present disclosure.

FIG. 2 is an exemplary flowchart illustrating a method for query execution, according to an embodiment of the present disclosure.

FIG. 3 is an exemplary flowchart illustrating a method for intelligent advertisement source selection, according to an embodiment of the present disclosure.

FIG. 4 is an exemplary flowchart illustrating a method for accessing, storing and merging advertisement result lists, according to an embodiment of the present disclosure.

FIG. 5 is an exemplary flowchart illustrating a merging process, according to an embodiment of the present disclosure.

FIG. 6 is an exemplary illustration of re-ranking results, according to an embodiment of the present disclosure.

### DETAILED DESCRIPTION OF EXEMPLARY EMBODIMENT(S)

The various embodiments of the present disclosure are directed to returning advertisement search results in a manner that maximizes results relevance while minimizing user perceived latency and platform resources, including consumed memory, processing, and network requirements. These qualities become increasingly important as the result set sizes and number of sources increase.

The following definitions are merely exemplary and referenced herein to illustrate the various embodiments of the present disclosure described below. The embodiments and scope of the disclosure are not limited by the definitions set forth below.

Advertisement: advertising messages adapted to be delivered digitally through a network. The advertising messages may be textual, audio, video, or any combination thereof. Any person, organization, company that may want to send advertisement to consumers may be referred to as advertisers. Also, providers of advertisement in a network environment may be referred to as advertisement vendors, which includes advertisement agencies that produce and provide advertisement.

Advertisement network: may refer to computer programs designed to index, store and retrieve advertisement information based on instructions from the user via a query. A process that executes an individual search against a single collection is called an advertisement network. A process that executes a search against multiple advertisement networks and/or databases and combines results is known as a federated advertisement management system.

A method of ranking results may involve determining a relevance score for a resource (e.g., resource, website, and image) in view of a query. A similarity score may be calculated for the query utilizing a feature vector that characterizes attributes and query words associated with the result. A rank value may be assigned to the result based on the relevance score, similarity score and/or other factors and criteria. In addition, advertisement relevancy may be improved by adaptively ranking, based on prior behavior of users and resources returned from an advertisement network, advertisement vendor, or other content source. More particularly, prior behavior of users may be assessed to determine a rate at which to apply adaptive correction for a given query.

Results lists are merged with a goal of placing the most relevant entries first for the user's convenience. To reduce the associated computational overhead, lists may not be merged based on an examination of every single entry. Rather, the lists may be merged based on an examination of a smaller number of entries from each list. A subset of entries may be selected from each list and the lists may be merged according to these subsets, rather than upon an evaluation of every single entry of every single list. The subsets may be selected according to a technique for selecting a few items out of a larger group. For example, a number n may be chosen and the top n resources may be selected from each list. According to another example, a number may be again chosen where the merging algorithm selects n resources that are uniformly spaced within each result list. According to yet another example, a number may be chosen and n resources may be selected at random from each list.

A scoring value may be determined for each entry in the various subsets selected. Scoring values may be numbers that typically represent how closely the entry matches the query, where certain number ranges indicate an entry that is likely to be relevant to the user. A representative score of all scoring values may be determined. The representative score may be an arithmetic average or a value proportional to the average for a set of scoring values.

All entries from all lists may then be merged or ranked based on at least the representative score for each list. Once each result list has a representative score assigned, it may be merged with the other lists accordingly. For example, entries may be merged by selecting the list with the highest representative value (e.g., highest average scoring value). The first entry on the list that has not already been selected may then be picked. That list's representative value may then be decremented by a fixed amount and the process may be repeated until all entries have been picked. If any representative value drops below zero after decrementing, it may be reset to its initial value or a predetermined value.

According to another example, entries may be merged using a probabilistic approach where each list may be assigned a probability value equal to its representative value's percentage of the total representative values for all lists. Lists may then be selected according to their probability value, with lists having higher probability values being more likely to be selected. When a list is selected, the first entry on that list that has not already been selected is picked. This process may be repeated, with the total representative value being revised when all entries of a list are picked.

Content Source: may refer to a publisher having collections of digital or non-digital content available via a network. Advertisement vendors may be referred to as content sources.

(Content) Source Ratings may refer to scores used to measure the relative usability of content sources for types of queries. Content source ratings may also be calculated by including content factors such as extensiveness or coverage, classification reliability, content quality and/or other information that affects the source's results relevance. Ratings may also be affected by business relationships and usage patterns. For example, a business relationship between a content source and a distributor may increase a source's rating in order to either choose a source over other sources in the source library, or to give the content source results items preference over other source results in the combined results set. Sources with a high percentage of no results returned may have a lower rating than one wherein a high percentage of queries have results items returned.

Source ratings may also consider performance factors such as latency, response reliability and/or other criteria. For example, reliability may refer to percentage of uptime for the source in an average one month period (or other time period). Latency may be measured as the time for query transmission by the query broker system to the content source plus the return trip time for the results set from the source back to the query broker system. For example, a source rating may be calculated by combining objective measures of the reliability of the source in responding to queries and the response latency with subjective measures of content coverage. For example, sources that are available 99% of a 24 hour day may have a higher source rating than those which are only available 93% of the day.

In addition, source ratings may be updated in response to variety of factors, such as, but not limited to, a query or set of queries, user traffic patterns, source responses, and/or advertising/marketing campaign considerations, using adaptive processes that depend on responses to prior queries, user choices, or other dynamic events.

Query: may refer to a request that describes or identifies information or data being sought by the user. The query may include various combinations of text, non-text, and/or user selected categories. For example, queries may include keywords (e.g., terms, phrases, natural-language sentences), as well as non-text queries (e.g. multimedia such as pictures or audio clips, and/or numerical queries such as auction bids, purchase prices, or travel dates), and/or categories (e.g. music genres such as Rock, Pop, or Urban).

Various combinations of query types and formats may be applied. For example, in the case of a travel reservation, a query may include a date range, departure and destination city pair and/or a number of people traveling. In the case of an audio file, the query may include verbal or musical phrases as well as artist names, song titles, etc. In more complex scenarios, a query may be characterized in terms of stock quotes, stock price derivatives, signal patterns, or isobars.

The user may transmit a query through a remote device, such as a phone, PDA and/or other mobile device. Further, the user may use a computer or other communication device to transmit a query.

Query Context: may include demographic information, such as user sex, age, and marital status; social networking information such as community, locale, group memberships; and/or other data may also be received by an advertisement network. A query context may include other user specifics such as language preferences, display preferences, time/date data and/or other information. A query context may include type of device (e.g., mobile phone, laptop computer, PDA, game console), device settings/limitations (e.g., size, graphics, audio, video, memory), response display settings (e.g., font, color). A query context may include a user's current location and/or preferred location, which may be used to preference relevant search results for location-related queries. For example, a user may search for a nearby pizzeria. The advertisement vendor or advertisement network may automatically return a list of pizza restaurants closest to the user's current location.

The query context may be automatically retrieved from the device and included in the query. In addition, the user may access a webpage or other user interface to provide and/or update user preferences, settings and/or other data to be included in the context.

Stored Query: The user may pre-program frequent searches, such as stock quotes, weather, update on favorite celebrities, etc. with no change to the underlying technology.

Results Item: an atomic piece of information. A results item is returned by an advertisement vendor or advertisement network and is used to refer to a specific document. Results items may include location of the information resource, and various other metadata values such as description, title, price, etc. Each advertisement returned by a search may be referred to a result item.

Results Set: A list of results items returned from an advertisement vendor or advertisement network in response to a query.

Categorization: may be defined as the placement of entities in groups, potentially hierarchical structured as taxonomies, whose members bear some similarity to each other. Categorization systems may involve the assignment to a resource of one or more group labels intended to represent the intellectual, functional, or conceptual content of that resource. These labels are usually drawn from a controlled vocabulary that normalizes the terminology and provides for communication between the information retrieval system and the individual or several information retrieval systems by specifying a set of authorized terms or labels that can be used to pose search queries.

Taxonomy: may be a hierarchically-arranged controlled vocabulary used to organize content in a collection. Internet advertisement vendors or advertisement networks may have one or more associated taxonomies to facilitate browsing search of the content collection. Web application developers and marketing may have split the organization of resources into two separate representations to satisfy the organizational uses of different stakeholders. A single taxonomy node is called a taxon. The plural of taxon is taxa.

Reference Taxonomy: may be fine-grained, monotonically expanding taxonomy used as a structure for manual or machine classification of the content items stored in the local collection.

Display Taxonomy: may be a subset of the reference taxonomy and is used for display to individuals accessing content. This display taxonomy may be more mutable than the reference taxonomy because it is used to highlight categories for individual browsing searches and content source staff may determine that it is more important to highlight one area of content this week and a different area next week. Even if the display taxonomy changes, the reference taxonomy will remain unchanged to avoid re-categorizing the entire content collection.

Source Taxonomy: may be the display taxonomy for a content source accessible by a federated advertisement system. In a federated advertisement system, there may be three levels of organization. For example, in addition to the display taxonomy viewable by individuals and a reference taxonomy level for organizing the resources available in the metacollection, the content source display taxonomies are indirectly available for user browsing.

The present disclosure relates in particular, to a method and system for a federated advertisement management system which categorizes the query and query context to choose the most relevant source(s) (e.g., advertisement vendors) from a set of multiple, distributed, heterogeneous advertisement sources to generate a combined search results set, ordered using source, user, distributor ratings and/or other factors with minimum latency to the user.

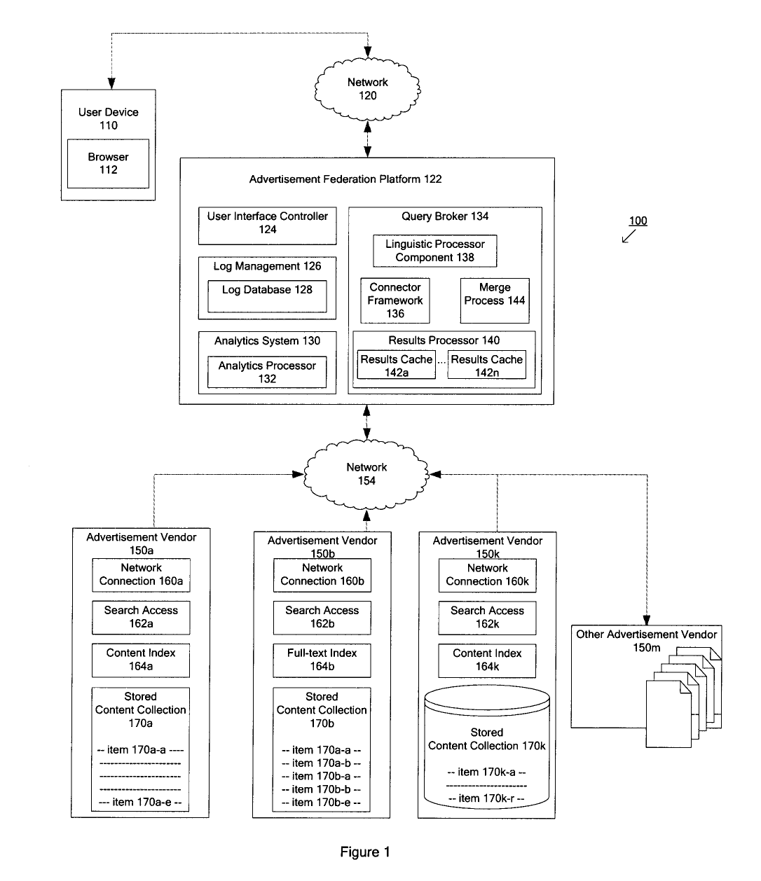

FIG. 1 is an exemplary diagram of a system 100 for federated advertisement searching to multiple advertisement sources, according to an embodiment of the present disclosure. The components of system 100 may be further duplicated, combined and/or separated to support various applications of the embodiments of the present disclosure. Additional elements may also be implemented in the system to support various applications.

System 100 is used to send a search query from User Device 110 to Advertisement Federation Platform 122 to request a set of advertisement results items satisfying the user query. User Device 110 may include a computer input device containing a client or browser program 112 that allows users to access the Internet. User Device 110 may include a mobile device or other communication device, including a terminal, such as a kiosk or desktop computer. User Device 110 may communicate via Network 120, which may include the Internet or other network, to Advertisement Federation Platform 122. Advertisement Federation Platform 122 may operate in a client-server, peer-to-peer, and/or other configuration.

Advertisement Federation Platform 122 may include a User Interface Controller 124. The User Interface Controller 124 may include a component that receives and packages query. The component may receive a query as an HTTP request via a gateway and then package the query with a query context (e.g., locale, user agent, user preferences and login, if available), and send it as a query state object to an advertisement classification system within the User Interface Controller 124. The advertisement classification system may analyze the query context, determine the most appropriate advertisement format(s) and annotate the query state to include a ranked list of appropriate advertisement format(s). The advertisement classification system may then send the query state object outside the User Interface Controller 124 to a Query Broker 134 and wait for a return of one or more relevant, appropriately formatted advertisement(s). Once the advertisement classification system receives the advertisements, it may remove any inappropriately formatted advertisements and return the query state object to an advertisement delivery controller component in the User Interface Controller 124. The advertisement delivery controller component may extract the advertisements from the query state object, create an HTTP response (or other type of response, e.g., xHTML, cHTML, wml, XML, etc.) appropriately formatted for the user's device and application.

As described previously, the Advertisement Federation Platform 122 may comprise a Query Broker 134. The Query Broker 134 performs advertisement source selection, results caches and merging source-specific result sets. The Query Broker 134 may communicate through Network 120 by wired or wireless network connection to user devices (e.g., User Device 110) and further communicate through Network 154 to advertisement sources (e.g., Advertisement Vendor 150a, 150b, . . . 150k,) and/or Other Advertisement Vendor 150m, e.g. “on-deck” advertisement sources.

The Query Broker 134 may include various modules to perform functionality associated with searching, retrieving and/or other processing. For example, Query Broker 134 may include a Linguistic Processor Component 138, Connector Framework 136, Merge Process 144, Results Processor 140, Results Caches 142a . . . 142n and/or other module(s). The various components of system 100 may be further duplicated, combined and/or integrated to support various applications and platforms. In addition, the modules, caches and other components may be implemented across multiple systems, platforms, applications, etc. Additional elements may also be implemented in the system to support various applications.

Linguistic Processor Component 138 may dynamically classify queries. An embodiment of the present disclosure may provide dynamic classification of a user query and/or query state using a taxonomic structure organizing any of content publishers, location, content subject or function, and/or other relevant content distinctions. The Linguistic Processor Component 138 may extract preferences and metadata associated with a query. The categorization functionality of the Linguistic Processor Component 138 may select or identify a relevant advertisement source subset from a library of advertisement sources. By dynamically computing the set of sources relevant to the user's information request at the time a query is presented, an embodiment of the present disclosure maximizes precision while minimizing retrieval costs of non-relevant content. The selection of the relevant advertisement sources may be based on content coverage and advertisement type, publishing medium (web, mobile device), user behavior and location, group and user preferences (e.g. demographics, etc.), business relationships and/or other factors and considerations.

The Linguistic Processor Component 138 may reformat the query into the source-specific query language and Connector Framework 136 may transmit the reformatted query to the respective advertisement source(s) (e.g., Advertisement Vendor 150a, 150b, . . . 150k). By reformatting the query into source-specific query language, more accurate results may be obtained more efficiently. Various source-specific query request input format may be implemented, such as, but not limited to, XML, Java, SQL and/or other formats. In response, results sets may be received from the respective advertisement sources by the Connector Framework 136.

Advertisement Vendors 150a . . . 150m may facilitate information retrieval from their content collections using several modules. Advertisement sources may communicate through Network 160a . . . 160m by wired or wireless network connection to user devices or other programs. Search Access module 162a . . . 162m may provide for parsing the incoming query using the advertisement management system proprietary indexing algorithm, matching the query to the content index and returning results sets that include metadata such as the description and location of the matching advertisement items. Index 164a . . . 164m may include a storage mechanism and computer program that may include metadata, text and/or other attributes from the resources contained in the vendor's content collection. The Stored Content Collection modules 170a . . . 170k may include resources, multimedia, and/or other advertisement content indexed by the advertisement management system, referenced by the metadata and accessible via the location listed in the results set.

The modules and other components of Advertisement Vendors may be implemented across multiple systems, platforms, applications, etc. Additional elements may also be implemented in the Content Source systems to support various applications.

The Stored Content Collections may include advertisement data items such as advertisement items [170a-a . . . 170a-e], and [170a-a, 170a-b, 170b-a, 170b-b, 170b-e]. For example, advertisement items may appear in one collection, as in items [170a-a . . . 170a-e]. However, advertisement items may also appear in more than one collection, as depicted by the overlap of the advertisement content sets [170a-a, 170a-b] in collections 170a and 170b. In such a case, multiple references to the same advertisement may appear in the results set of a federated advertisement management system which invokes both of these external vendors. This situation may exist when advertisement resellers publish the same advertisement to their respective constituents, varying the presentation to the user by various factors such as language, content ranking, organization, billing arrangement and/or other consideration. The Advertisement Federation Platform 122 may further retain or remove duplicates in such a way as to create a fair representation of multiple collections.

According to an embodiment of the present disclosure, Connector Framework 136 may receive the results from the respective advertisement sources (e.g., advertisement vendors, databases, other sources of data, etc.) and further store the results in query/source-specific Results Caches 142a . . . 142n. A Results cache may contain the results set returned from an advertisement source in response to a specific query, e.g. keyword, term set, hummed phrase, or category. Results Caches may also be time-sensitive where the results become unusable after a predetermined period of time, such as a specified number of minutes or hours, to retain content freshness. Caches may also have an associated unique cache key which may include source identification, query or category terms, and/or other factors to facilitate reuse.

Query-specific caches (e.g., Results Caches 142a . . . 142n) may store results returned from advertisement sources 150a . . . 150m and store merged results sets for post-processing at Results Processor 140. Results Processor 140 may then compile and possibly cache the combined list to produce a single ranked results list for the user using Merge Process 144. The separate source-specific lists and the combined lists may be reusable within a configurable time period for responses to subsequent queries by the same or other users. The Results Processor 140 may also check the returned advertisements for consistency and quantity. For example, if fewer advertisements than requested were returned, the Results Processor 140 may augment the response with advertisements from an internal category-level cache and/or other source.

Merge Process 144 may merge different result sets into a single list (or other format) in an order based a configurable algorithm which may determine an order based on ad text, metadata, ad agency content quality and delivery reliability, business relationships with the agencies and/or other factors and considerations. For example, other factors may include: when a time threshold passes; or other condition is met. For example, an embodiment of the present disclosure may be directed to merging results, after waiting 100 ms for source responses, based on advertisement source ratings. In addition, the results may also be ranked based on internal content relevancy scores, and/or other result specific criteria. For example, after individual results are received, the Merge Process 144 may merge the source-specific results according to a merging algorithm or program, which may include local ranking scores, source ordering values, source-specific general scores and/or other source factors as well as result-based ranking, such as relevancy or accuracy, and usage factors such as demographics, traffic patterns, user personalization and community values, etc. The Merge Process 144 may retain or remove duplicate results according to user, device and/or other preferences or processes that may be applied to the results. After a single list (or the format) has been generated, the Query Broker 134 may then return a final advertisement set to the User Interface Controller 124, which may render the results appropriately for a mobile device and return the results through the network 120.

The Advertisement Federation Platform 122 may further comprise a Log Management component 126 and an Analytics System 130. The Log Management component 126 may include a Log Database 128. The Log Database 128 may include tables used to organize access and click through traffic, query object changes, advertisement access, and account management. The Log Management component 126 may work with the Advertisement Classification System of the User Interface Controller 124 to log the system behavior for analysis of system performance. As described previously, the incoming query and query context may be moved through the system as a query state object. This object may be logged at its initial creation where one or more of the following changes to the query state object may be logged: the appropriate advertisement formats, advertisements returned from the Query Broker 134, and delivery format.

Log Management component 126 may extract data for use in one of three main functions: User behavior (e.g., visits, click-through, etc.), system functionality (e.g., core debugging of application performance), and Account Management (e.g., advertisers, advertisement agency, etc.).

The Analytics System 130 may include an Analytics Processor 132. The Analytics Processor 132 may analyze data stored in the Log Database 128 for usage and behavior, keyword frequency and pricing changes, category return on investment, advertiser and agency performance, advertisement campaign performance and/or other activity. It may take into account user profiling, geo-targeting, time and day fluctuations and/or other data. The Log Management component 126 may also compile data for use by the Analytics System 130. For example, the Analytics Processor 132 may use the compiled data for Keyword Optimization (e.g., return on investment, major keywords, advertiser/agency optimization) and/or other functions.

The Analytics System 130 may further include an Account Management module (not shown), which may provide reporting and billing functions. The Account Management module may manage one account per advertiser or agency, provide login authentication, secure access to analytical reports generation by the Analytics Processor 130 and bill data generated by an internal billing sub-module. The Analytics System 130 may be a monetization component that tracks advertisement delivery, clicks for processing by the Analytics Processor 132 and/or other activity. The Analytics Processor 132 may be extended with adaptive learning processes to forecast the advertisement source which may contain the advertisement of highest value, for example. The Advertisement Federation Platform 122 may then select or preference advertisements from that source, which may include some specific advertisement vendors and/or other sources.

An exemplary embodiment of the present disclosure may utilize system architecture to provide a more manageable monetization engine to operator-based advertisement delivery for mobile data services. Additionally, the architecture allows for the creation of monetizable, regionally-focused search services using a common business and technical processes across advertising and search services. The exemplary embodiment may be architected for integration ease, configurability, and scalability. Therefore, the exemplary embodiment may allows business as well as technical decisions to drive the choice of the external ad agency partners, and to move rapidly to take advantage of new monetization opportunities.

For example, one exemplary embodiment of the present disclosure may provide the following: total control of the user experience; monetized search listings, mobile sites and mobile services according to multiple services models, configurable for each distribution venue; maximized ad revenue by ensuring all ad vehicles fully deliver in response to user behavior; minimized risk and reduce reliance on specific advertisement sources, maximizing leverage in the marketplace; major keyword Pay Per Click (PPClick) advertisements to users under the group brands; long tail keyword PPClick advertisements via a single request/response model that is fully integrated with the major keyword advertisements; ability to stay ahead of the market through the rapid integration of new advertisement model services, such as Pay Per Action (PPAction) and Pay Per Call (PPCall), affiliate partners, and flat link services from emerging advertisement agencies or emerging geographic regions; minimized capital, operating, and development expenditure on mobile sites, search listings, and mobile services by providing a hosted service with a single, simple API to all advertisement service agencies; and rapid deployment of customized advertisement services.

One exemplary embodiment may implement features that include dynamic advertisement request categorization for maximizing the number of relevant advertisements returned from the advertisement vendor per request, usage and community modeling to increase advertisement relevance and maximize click through rates (CTR), advertisement vendor rating and request rotation, multi-vendor advertisement request responses, and total traffic analysis to focus future advertising development.

In another exemplary embodiment of present disclosure, an Advertisement Federation Platform may provide a single request format for use by developers and may further dynamically reformat the request to support various ad agency request query language, parameter set, metadata mapping and/or other criteria.

In one or more exemplary embodiments of the present disclosure, an Advertisement Federation Platform may also seamlessly leverage multiple advertisement agency taxonomy and ad classification systems to increase advertisement relevance and maximize marketing return on investment. Generally, return on investment may refer to the advertisement partner's ability to generate revenue from a given project(s) to offset costs associated with the development, implementation and maintenance of the project.

For example, advertising content may be integrated into an external agency advertisement content by building a connector from the Advertisement Federation Platform. The Advertisement Federation Platform may serve client content alone or combine it with other advertisement agency as well as other content based on business rules determined by management and/or other factors. The Advertisement Federation Platform may then automatically include major word advertisements and/or other advertisements, content, etc. in response to the requests.

In one or more exemplary embodiments of the present disclosure, an Advertisement Federation Platform may support native language input and returns ad results in UTF-8 in real-time. For example, search results may be returned in UTF-8 (or other similar) format in real time, meaning that the results are returned to the user directly from an advertisement partner's content stores, as opposed to cached content.

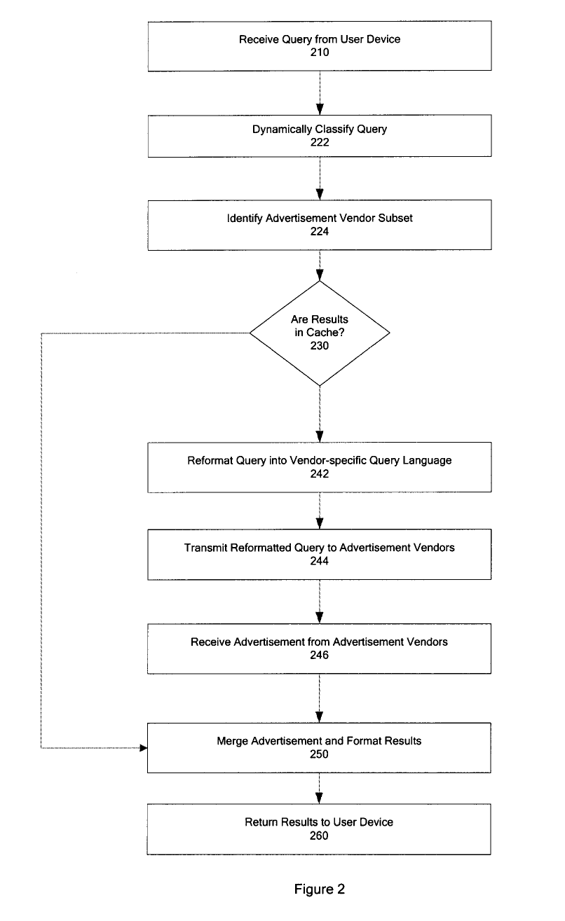

FIG. 2 is an exemplary flowchart illustrating a method for query execution, according to an embodiment of the present disclosure. A method of an embodiment of the present disclosure selects a relevant subset of possible advertisement sources available to an advertisement management system, such as a federated advertisement management system, sends a reformatted query to each advertisement source in the subset, receives and caches each results set, then merges the results sets into a single combined results set.

As shown by FIG. 2, a query may be received from a user at step 210. At step 222, the query may be dynamically classified against one or more taxonomies organizing the advertisement source library, advertisement subject and functional aspects, and/or user and operator characteristics. At step 224, an advertisement source subset may be identified from the available advertisement source library. At step 230, results caches may be checked for pre-existing results sets. If no results exist in the cache for the query and query context, the Query Processor proceeds through steps 242, 244, and 246. At step 242, the query may be reformatted into the source-specific query language(s) particular to the advertisement source subset. At step 244, the reformatted query may be transmitted to advertisement sources, such as advertisement vendors, advertisement networks, databases and/or other sources of data. At step 246, advertisement may be received from the advertisement sources and stored in local results caches. At step 250, results from advertisement sources may be merged and further reformatted. At step 260, the results may be returned for display to the user. While the steps of FIG. 2 illustrate certain steps performed in a particular order, it should be understood that the embodiments of the present disclosure may be practiced by adding one or more steps to the processes, omitting steps within the processes and/or altering the order in which one or more steps are performed.

An embodiment of the present disclosure provides dynamic categorization of a user query and/or query state against a pre-categorized library of advertisement sources. The query may be categorized at runtime by Query Broker 134, at step 222. For example, a user may search for mobile phone games using the keyword, “auto racing”. For example, the Query Broker 134, at step 222, may classify the query as a “Mobile Game” query and thereby identify a set of mobile game advertisement sources. In addition, the granularity of the query category may be adjusted to refine the search results. For example, the query may be a request for games about auto racing. In this case, the query may be categorized as “Mobile Game” and “Action.” Accordingly, an advertisement source subset may be identified as maximally relevant to the combination of the two categories. Other variations may be applied.

By dynamically computing a set of sources relevant to the user's information request at the time a query is presented, an embodiment of the present disclosure maximizes precision for the query. In addition, the amount of data transmitted over the network may be minimized over other federated advertisement management technologies, thereby providing efficient bandwidth utilization. Furthermore, topology of the federated advertisement source selection mechanism readily supports a multi-tier hierarchy of advertisement vendors and other sources, thereby facilitating the scalability of the search system to any number of advertisement content collections, advertisement networks and/or other sources of data.

At step 224, a content source subset may be identified. The categorization functionality of the Query Broker 134 may select or identify a relevant advertisement source subset from a library of possible advertisement sources.

At step 230, one or more results caches may be checked. In accordance with an embodiment of the present disclosure, results caches may be checked for previously returned results. An embodiment of the present disclosure may be directed to retrieving results for a query from cache thereby allowing reuse of the results for identical and/or related queries from other users. As a result, network transmission may be minimized and the effects of network latency to the users may be reduced. Therefore, if it is determined that query results are already stored in a local internal or external cache, these results may be used directly or merged with results from other advertisement networks, at step 250 for return to the user.

If no results were in cache, at step 242, the query may be reformatted into source-specific query language. For example, the Query Broker 134 may reformat the query into the source-specific query language for one or more advertisement sources. At step 244, the reformatted query may be transmitted to advertisement sources.

At step 246, advertisements may be received from the respective advertisement sources. In addition, each advertisement source may pre-determine scores, ranking and/or other rating for the content in their respective collections pursuant to the query. Further, the results items may show an implicit ranking by being transmitted to the Query Broker 134 as an ordered results list. The Query Broker 134 may receive the results from the respective advertisement sources (e.g., advertisement vendors, advertisement networks, databases, other sources of data, etc.) and further store the results in local internal or external results caches. Local results caches may be specified by a query, a specific content source, a group of sources, the type of source and/or other categorizations.

At step 250, advertisement from the advertisement sources may be merged and further formatted. After individual results are received or when a time threshold passes, the program may merge the source-specific results according to a merging algorithm or program, which may include local ranking scores, source ordering values, source-specific general scores, usage scores, user or distributor scores, and/or other factors. At step 250, the combined results list is compiled to produce a single ranked results list for the user. The separate, source-specific and combined lists are also reusable within a configurable time period for response to subsequent queries by the same or other users. In addition, duplicate results may be retained or removed and other preferences may be applied to the results. The results may include an advertisement source reference with each result item to indicate the advertisement source. For example, an embodiment of the present disclosure may be directed to merging the results in an order based on various factors, which may involve source factors, such as advertisement quality and extensiveness, advertisement source latency and reliability, business relationships, externally determined quality ratings (such as Zagat ratings, etc.), individual and community usage patterns, and/or other ratings and calculations. In addition, the results may also be ranked based on text and metadata relevancy, and/or other result-specific criteria.

For example, at least one global statistic related to advertisement items in the results set may be computed. This may include a score normalization factor comprised of the results item rank and the source rating. In addition, advertisement relevancy scores for the results items from the advertisement sources may be determined, in accordance with the global statistic. Further, the scores may be normalized in accordance with the normalization factor for the metacollection, an external similarity scores, and the results metacollection items order as returned from the advertisement sources in accordance with the source statistic.

At step 260, the results may be displayed to the user. User device specifics and/or user preferences may be considered when displaying the results to the user. For example, as mobile devices may have screen size limitations, the results item description or title may be truncated and/or otherwise modified to accommodate the user's device and/or other preferences.

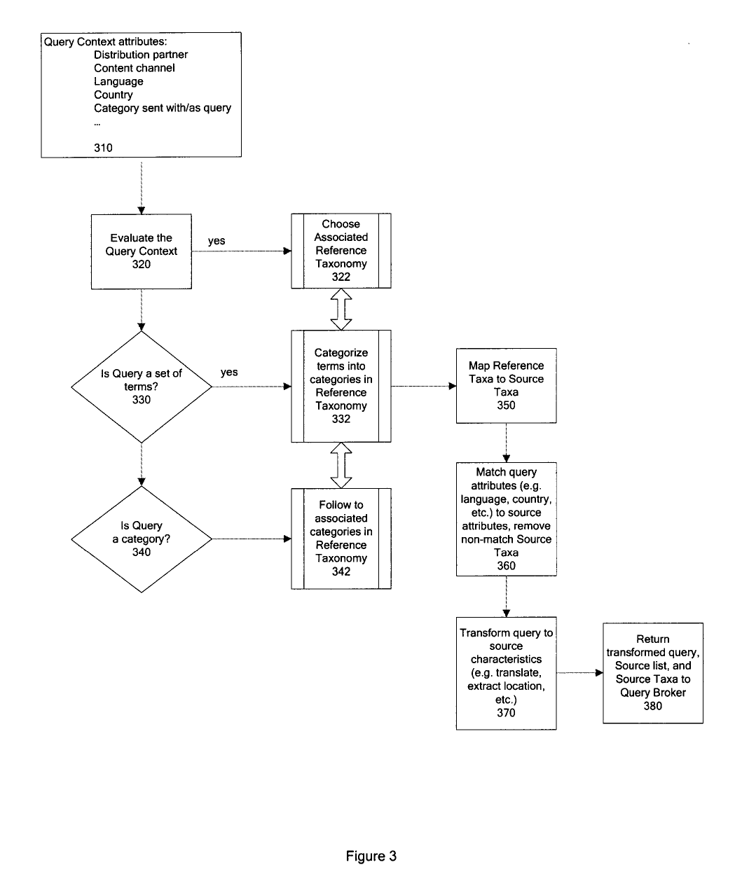

FIG. 3 is an exemplary flowchart illustrating a method for intelligent advertisement source selection, according to an embodiment of the present disclosure. An embodiment of the present disclosure is directed to identify a relevant advertisement source subset from an advertisement source library of advertisement vendors and databases. The categorization process may analyze the query and its attributes and identify a relevant subset of advertisement sources. Query Broker 134 may utilize a categorization process to assign a query to a relevant taxon or taxa in the reference taxonomy and choose the optimal set of related advertisement source taxa which uniquely identify advertisement sources.

At step 310, one or more query context attributes may be identified. For example, attributes may include distributor, vertical search channel, language, country, artist, title, price, and/or other metadata associated with the query and/or user.

At step 320, the computer program may evaluate the query context attribute values. Associated reference taxonomy may be selected, at step 322 in response to the vertical search selection and other context parameter values. The computer program may determine whether the query is a set of terms or a category, at step 330. Terms may refer to word(s), phrase(s), etc. If so, the terms may be assigned to categories in the associated reference taxonomy or taxonomies, at step 332 using a dynamic machine classification process. The computer program determines whether the query is a category from the display taxonomy, at step 340. If so, an associated category may be identified in the reference taxonomy, at step 342. At step 350, the selected reference taxonomy category may be related with the advertisement source taxon or taxa associated with each selected advertisement source. At step 360, the query and query context values may be transformed to match advertisement source metadata fields and values, which may involve translation, user preference extraction, etc. At step 370, query context attributes (e.g., language, country, etc.) may be matched to one or more advertisement source attributes and the context attribute names may be mapped to advertisement source attribute names. At step 380, the advertisement source taxa list, matching metadata attribute names and values and transformed query may be returned to the Query Broker 134.

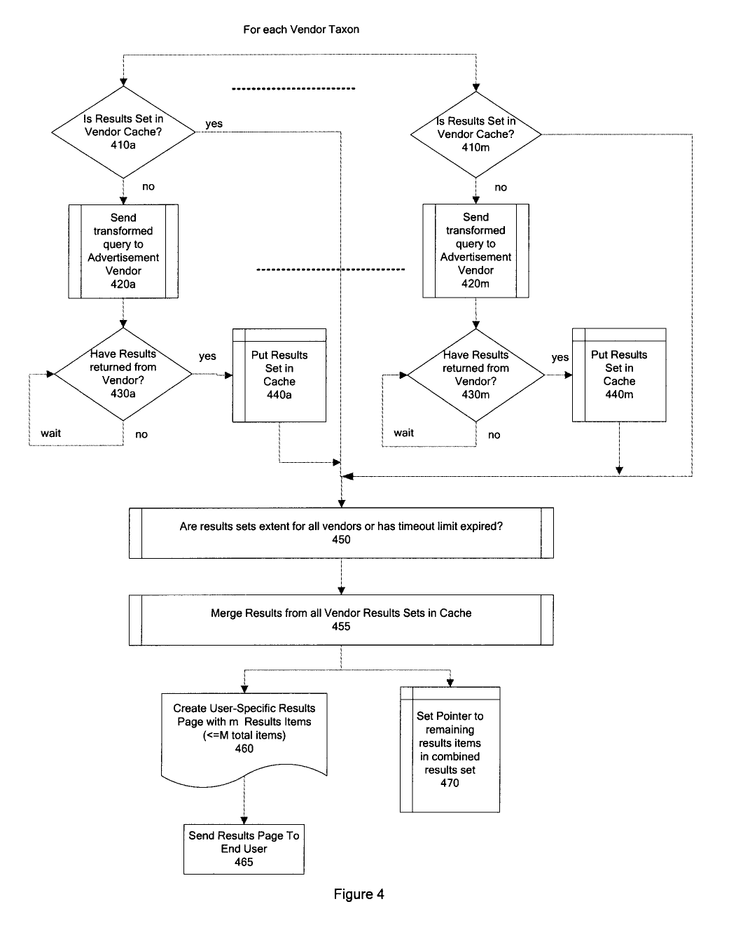

FIG. 4 is an exemplary flowchart illustrating a method for accessing, storing and merging advertisement result lists, according to an embodiment of the present disclosure. As discussed above, a subset of advertisement sources may be identified and the associated taxon is returned to the query broker system. For each advertisement source and the query, it may be determined whether an existing result set resides in a results cache, at step 410a . . . 410m and 450. If results exist, they are merged at step 455 based on the incoming query context attribute values. At this step, previously stored results may be retrieved from the results cache(s).

If results do not exist, the query may be reformatted into an advertisement source-specific query language and transmitted to a respective advertisement source, at step 420a . . . 420m. The query broker system may wait for results from each advertisement source, at step 430a . . . 430m. A wait timeout, or other predetermined condition, may be implemented to ensure efficiency. Once the results are received, the results may be stored in the results cache, at step 440a . . . 440m. At step 450, it may be determined whether all advertisement sources have returned results or the timeout limit has expired. At step 455, all results items in cached results sets are merged into a single, combined results set based on the incoming query context attribute values. The merging algorithm may then cache the merged list to produce a single ranked results list.

As shown by step 460, additional processing may involve taking the top or next m items from the combined results set to create a user-specific results page. In addition, the Query Broker 134 may check the results list for duplicates and group, remove or retain them according to system and distributor preferences. This step may consider query context attributes such as, but not limited to, device specifics, user preferences, and/or distributor limitations in creating the results page. At step 465, the results page may be sent to the user via a wired or wireless communication channel. At step 470, a pointer may be set to the remaining results items in the combined results list (at the m+1th result item).

The merging process may calculate a global statistic for each advertisement results item in each results set returned by advertisement sources in response to a query. This global statistic is a function of two or more factors: the relevance of the result item to the query, represented by a similarity score or ranking determined by the advertisement source and included explicitly or implicitly with the results items; and external characteristics such as, but not limited to, a source rating, usage parameter values, user preference score, or distributor preference value.

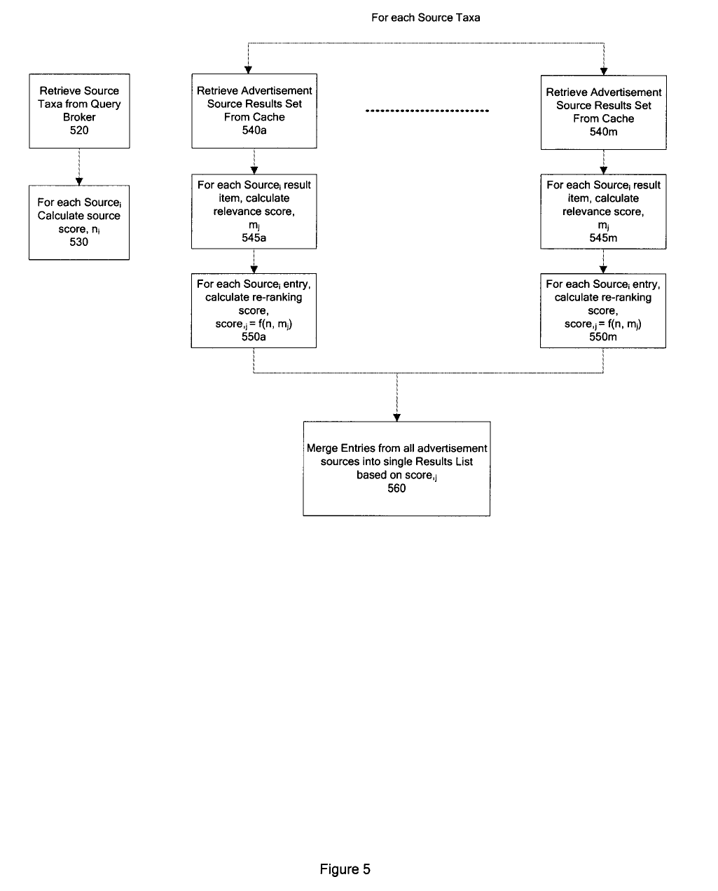

FIG. 5 is an exemplary flowchart illustrating a merging process using rank order as the results item score and source ratings to represent external characteristics, according to an embodiment of the present disclosure.

After all individual results are received, the Query Broker 134 may merge the results according to a merging algorithm which includes general scores (e.g., nⱼ) and results-specific relevance scores (e.g., mⱼ). For example, source taxa may be retrieved using taxa identifiers stored in the query context at step 520. At step 530, for each advertisement source, a source score (e.g., nᵢ) may be calculated from attribute values stored in each source taxon. For each advertisement source, results items are retrieved from the associated cache, at step 540a . . . 540m For each advertisement source results item, an item score (e.g., mⱼ) may be determined, at steps 545a . . . 545m; and a reranking score (e.g., scoreᵢⱼ=f(nᵢ, mⱼ)) calculated, at steps 550a . . . 550m. The Query Broker 134 may compile the merged list using scoreᵢⱼ to produce a single ranked results list for the user, as shown by step 560.

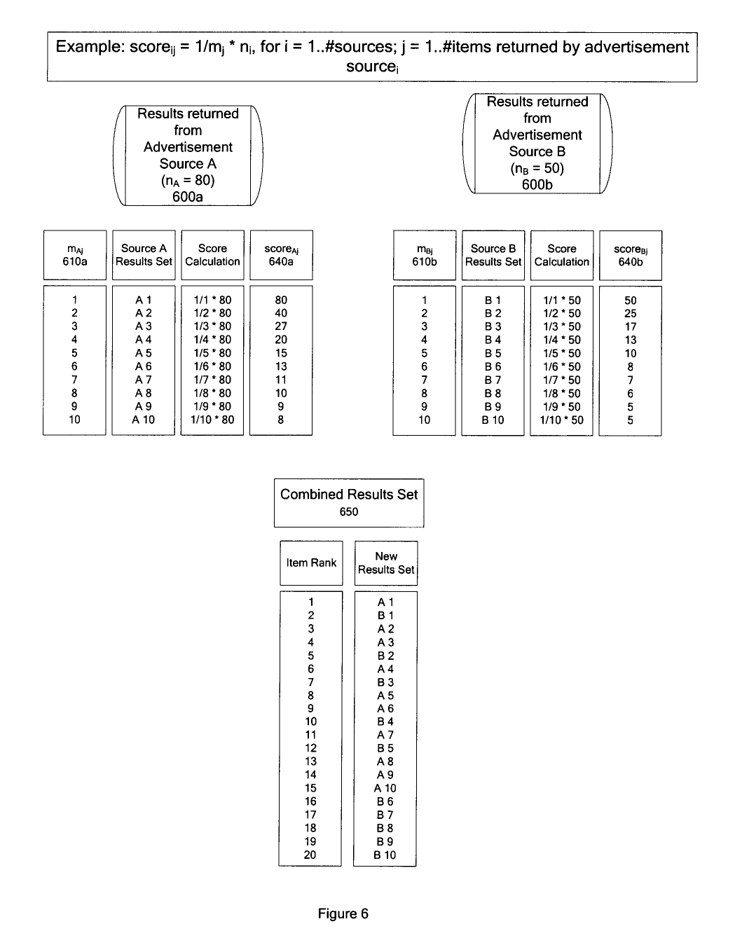

FIG. 6 is an exemplary illustration of re-ranking results items from results sets returned by multiple advertisement sources, according to an embodiment of the present disclosure. In this example, Advertisement Source A may have a source rating, n_{A}, of 80 and Advertisement Source B may have a source rating, n_{B}, of 50, as shown by 600a and 600b, respectively. A local statistic for each item in the respective results sets may be calculated as a function of the item order, m_{Aj} and m_{Bj}, as shown by 610a and 610b. A global statistic, the reranking scoreᵢⱼ, may be calculated as a function of the result item rank, mᵢⱼ, and the source rating, nᵢ, such that scoreᵢⱼ for each results item is the product of the inverse rank for each result item multiplied by the source rating, as shown by 640a and 640b. The combined results set contains items from Advertisement Source A and items from Advertisement Source B and is arranged by sorting the respective results items by their associated global scoreᵢⱼ, as shown by 650.

As discussed above, each content source (e.g., advertisement network, database, etc.) may determine scores for the content in the respective collections pursuant to the query. The Connector Framework may receive the results from the individual advertisement networks, calculate local ranking scores per item, and store the results, which may include respective ranking and/or other scores, in source-specific caches. After all individual results are received, a time threshold passes or other precondition is met, the query broker system may merge the results according to a merging algorithm. The merging algorithm may consider local ranking scores, source specific general scores and/or other factors and conditions.

According to an embodiment of the disclosure, the systems and processes described in this disclosure may be implemented on any general or special purpose computational device, either as a standalone application or applications, or even across several general or special purpose computational devices connected over a network and as a group operating in a client-server mode. According to another embodiment of the disclosure, a computer-usable and writeable medium having a plurality of computer readable program code stored therein may be provided for practicing the process of the present disclosure. The process and system of the present disclosure may be implemented within a variety of operating systems, such as a Windows® operating system, various versions of a Unix-based operating system (e.g., a Hewlett Packard or a Red Hat Linux version of a Unix-based operating system), or various versions of an AS/400-based operating system. For example, the computer-usable and writeable medium may be comprised of a CD ROM, a floppy disk, a hard disk, or any other computer-usable medium. One or more of the components of the system or systems embodying the present disclosure may comprise computer readable program code in the form of functional instructions stored in the computer-usable medium such that when the computer-usable medium is installed on the system or systems, those components cause the system to perform the functions described. The computer readable program code for the present disclosure may also be bundled with other computer readable program software. Also, only some of the components may be provided in computer-readable code.

Additionally, various entities and combinations of entities may employ a computer to implement the components performing the above-described functions. According to an embodiment of the disclosure, the computer may be a standard computer comprising an input device, an output device, a processor device, and a data storage device. According to other embodiments of the disclosure, various components may be computers in different departments within the same corporation or entity. Other computer configurations may also be used. According to another embodiment of the disclosure, various components may be separate entities such as corporations or limited liability companies. Other embodiments, in compliance with applicable laws and regulations, may also be used.

According to one specific embodiment of the present disclosure, the system may comprise components of a software system. The system may operate on a network and may be connected to other systems sharing a common database and common servers operating additional data or application services. Other hardware arrangements may also be provided.

Other embodiments, uses and advantages of the present disclosure will be apparent to those skilled in the art from consideration of the specification and practice of the disclosure disclosed herein. The specification and examples should be considered exemplary only. The intended scope of the disclosure is only limited by the claims appended hereto.

While the disclosure has been particularly shown and described within the framework of query processing, it will be appreciated that variations and modifications can be effected by a person of ordinary skill in the art without departing from the scope of the disclosure. Furthermore, one of ordinary skill in the art will recognize that such processes and systems do not need to be restricted to the specific embodiments described herein.

1. A computer implemented method for determining relevant advertisements in response to a query, the method comprising:
receiving a query from a user device;
categorizing the query to identify one or more advertisement sources;
formatting the query according to one or more advertisement source specifics for the one or more advertisement sources;
transmitting the formatted query to the one or more advertisement sources;
merging results in response to the formatted query from the one or more advertisement sources based at least in part on one or more factors; and
formatting the results for delivering to the user device.

2. The method of claim 1, wherein the user device comprises one or more of an internet-enabled input device, an internet or voice-enabled mobile device, a voice-enabled input device, a computer, and a kiosk.

3. The method of claim 1, wherein the one or more factors comprise one or more global factors, local factors, editorial rating, response reliability, response latency, content relevance, content extensiveness or coverage, user preferences, usage statistics, query frequency, category frequency, distributor preferences, recommendation statistics, user-generated ratings, business relationships, user demographic characteristics, location, language, social networks, social groups, personalization characteristics, page size, graphic, text elements, source rating, reliability factor, business rules, business relationships, marketing goals, local ranking scores, source ordering values, source-specific general scores, statistics associated with results item textual or non-textual analysis, statistics associated with data or text mining analyses, statistics associated with data or textual clustering, statistics associated with non-textual pattern analysis, statistics associated with device specifics and/or statistics associated with formatting specifications.

4. The method of claim 1, wherein the query is classified into a category in one or more taxonomy or controlled vocabulary.

5. The method of claim 1, further comprising:
dynamically computing one or more local ranking statistics for each results item related to one or more terms associated with the query and related to metadata in the query context in response to the query, at each advertisement source.

6. The method of claim 1, further comprising:
computing at least one global and/or one local statistic related to one or more content items in the results sets;
determining one or more relevancy scores for the results items from the one or more advertisement sources in accordance with the at least one global and/or one local statistic;
computing a normalization factor;
normalizing the one or more relevancy scores in accordance with the normalization factor; and
combining the results into a single results set based on an ordering determined by the normalization factor.

7. The method of claim 1, further comprising:
storing results from each advertisement source in one or more caches;
accessing the one or more caches to retrieve existing results; and
formatting the retrieved existing results based on one or more query context parameters.

8. The method of claim 1, wherein categorizing the query occurs dynamically at the time the query is received.

9. The method of claim 1, further comprising:
identifying one or more duplicate result items.

10. The method of claim 9, further comprising:
removing the one or more duplicate result items according to one or more of user preference, device preference and distributor preference.

11. The method of claim 9, further comprising:
retaining the one or more duplicate results according to one or more of user preference, device preference and distributor preference.

12. A computer readable media comprising code to perform the acts of the method of claim 1.

13. A computer implemented system for determining relevant advertisements in response to a query, the system comprising:
a receiving module for receiving a query from a user device;
a categorizing module for categorizing the query to identify one or more advertisement sources;
a formatting module for formatting the query according to one or more advertisement source specifics for the one or more advertisement sources;
a transmitting module for transmitting the formatted query to the one or more advertisement sources;
a merging module for merging results in response to the formatted query from the one or more advertisement sources based at least in part on one or more factors; and
a results module for formatting the results for delivering to the user device.

14. The system of claim 13, wherein the user device comprises one or more of an internet-enabled input device, an internet or voice-enabled mobile device, a voice-enabled input device, a computer, and a kiosk.

15. The system of claim 13, wherein the one or more factors comprise one or more global factors, local factors, editorial rating, response reliability, response latency, content relevance, content extensiveness or coverage, user preferences, usage statistics, query frequency, category frequency, distributor preferences, recommendation statistics, user-generated ratings, business relationships, user demographic characteristics, location, language, social networks, social groups, personalization characteristics, page size, graphic, text elements, source rating, reliability factor, business rules, business relationships, marketing goals, local ranking scores, source ordering values, source-specific general scores, statistics associated with results item textual or non-textual analysis, statistics associated with data or text mining analyses, statistics associated with data or textual clustering, statistics associated with non-textual pattern analysis, statistics associated with device specifics and/or statistics associated with formatting specifications.

16. The system of claim 13, wherein the query is classified into a category in one or more taxonomy or controlled vocabulary.

17. The system of claim 13, further comprising:
a module for dynamically computing one or more local ranking statistics for each results item related to one or more terms associated with the query and related to metadata in the query context in response to the query, at each advertisement source.

18. The system of claim 13, further comprising:
a module for computing at least one global and/or one local statistic related to one or more content items in the results sets, wherein one or more relevancy scores are determined for the results items from the one or more advertisement sources in accordance with the at least one global and/or one local statistic; and
a module for computing a normalization factor, wherein the one or more relevancy scores are normalized in accordance with the normalization factor; and the results are combined into a single results set based on an ordering determined by the normalization factor.

19. The system of claim 13, further comprising:
one or more caches for storing results from each advertisement source, wherein the one or more caches are accessed to retrieve existing results; and wherein the retrieved existing results are formatted based on one or more query context parameters.

20. The system of claim 13, wherein categorizing the query occurs dynamically at the time the query is received.

21. The system of claim 13, wherein one or more duplicate results are identified.

22. The system of claim 21, wherein the one or more duplicate results are removed according to one or more of user, device and distributor preferences.

23. The system of claim 21, wherein the one or more duplicate results are retained according to one or more of user, device and distributor preferences.
